(19) United States
(12) Patent Application Publication
(10) Pub. No.: US 2024/0050972 A1
(43) Pub. Date: Feb. 15, 2024

(54) Vessel and System for Reducing Packaging Waste

(71) Applicant: Circulr Research Pty Ltd, Collingwood, Victoria (AU)

(72) Inventor: Joel Wells, Collingwood, Victoria (AU)

(21) Appl. No.: 18/259,463

(22) PCT Filed: Dec. 14, 2021
(86) PCT No.: PCT/AU2021/051486

§ 371 Date: Jun. 27, 2023

(30) Foreign Application Priority Data
Dec. 28, 2020 (AU) 2020904859

(51) Int. Cl. B05B 11/10; B65D 47/00; B65D 17/00; B65D 17/50; B65D 77/06; A47G 19/32

(52) U.S. Cl. CPC B05B 11/1047; B65D 47/00; B65D 17/02; B65D 17/501; B65D 77/06; A47G 19/32; A45D 34/00

(57) ABSTRACT

A system for holding and dispensing a movable substance such as a personal care products. The system includes a thin-walled vessel for holding the substance having a support formed about an upper end thereof and a deformable lateral wall. Further included is a vessel housing having an upwardly facing opening and a dispenser to convey the substance from the vessel. A dispenser retainer engages the housing and retains the dispenser within the vessel interior. The vessel housing or the dispenser is configured to contact the support so as avoid or lessen deformation of the lateral wall upon actuation of the dispenser.

### FIELD OF THE INVENTION

The present invention relates generally to means for holding and delivering substances for which rigid plastic containers are typically used. Such substances include products sold in pharmacies, hardware stores, office supply stores, and suppliers of products used in heavy and light industry. Exemplary products which may be held and delivered by the present invention include personal care products, household agents, cleaning products, horticultural products, food products and the like.

### BACKGROUND TO THE INVENTION

The environmental problem of manufacturing and disposing of vessels used to hold products such as personal care products, household agents, cleaning products, horticultural products, food products and the like is well established. Significant volumes of input materials are used globally in the manufacture of such vessels, including plastics, metals, and cardboard.

It is often the case that a vessel must be fabricated so as to resist deformation, puncturing, and also prevent damage to the contained goods in the course of use. One example is the liquid soap dispensing system which is virtually ubiquitous in bathrooms across the developed world. The liquid soap is contained in a vessel having a threaded neck, with a dispensing mechanism (typically a pump) being wound onto the threaded neck. The dispensing mechanism is actuated by the consumer to move the liquid soap from inside the vessel and onto the consumer's hand. The vessel must be capable of not only securely holding the product, but also providing physical support for the dispensing mechanism and to maintain the entire system in an upright orientation. This arrangement requires the vessel to be constructed from significant amounts of input material (plastic or otherwise) with the concomitant use of significant amounts of input energy.

Even where the vessel is made from recycled materials (and may itself be recyclable), there is nevertheless an energy cost associated with the collection and processing of each unit weight of material in a recycling stream. The energy used in collection and processing is undesirable not only in terms of economic cost, but also environmental cost given the need to burn fossil fuels and release carbon dioxide.

A further problem of using recyclable material for the vessel is that some consumers will simply discard the vessel into the normal waste stream and the material is sent to landfill. Even when plastic recyclables are properly processed, there is the problem that there is some degradation in the hydrocarbon chains during processing. Accordingly, significant amounts of virgin plastic are often required to be mixed with recycled plastics in order to achieve the required physical properties in the final plastic product

It is an aspect of the present invention to provide an improvement to prior art vessels for holding movable household products, personal care products, foodstuffs and also industrial products. It is a further aspect of the present invention to provide a useful alternative to prior art vessels.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In a first aspect, but not necessarily the broadest aspect, the present invention provides a system for holding and dispensing a movable substance, the system comprising: a vessel configured to hold a movable substance, the vessel comprising (i) a support formed about an upper end thereof and (ii) a deformable lateral wall; a vessel housing having an upwardly facing opening, a dispenser configured to cause or allow a movable substance to flow from the vessel to outside the system, and a dispenser retainer configured to engage the vessel housing and retain the dispenser in operable association with the vessel interior, wherein the vessel housing or the dispenser is configured to contact the support so as avoid or lessen deformation of the lateral wall upon actuation of the dispenser.

In one embodiment of the first aspect, the vessel lateral wall has a thickness of equal to or less than about 0.5 mm, 0.4 mm, 0.3 mm, 0.2 mm or 0.1 mm.

In one embodiment of the first aspect, the vessel lateral wall has a thickness of equal to or less than about 0.3 mm.

In one embodiment of the first aspect, the support is a vessel lip having a thickness of equal to or greater than about 0.1 mm, 0.2 mm, 0.3 mm, 0.4 mm, 0.5 mm, 0.6 mm, 0.7 mm, 0.8 mm, 0.9 mm or 1.0 mm.

In one embodiment of the first aspect, the vessel lip has a thickness of equal to or less than about 0.3 mm.

In one embodiment of the first aspect, the vessel support has a thickness greater than that of the lateral wall.

In one embodiment of the first aspect, the vessel lateral wall is fabricated from a deformable polymer or a flexible polymer.

In one embodiment of the first aspect, the vessel is fabricated completely or predominantly from a polymer

In one embodiment of the first aspect, the vessel is fabricated completely or predominantly from a single polymer In one embodiment of the first aspect, the vessel is fabricated by a process of vacuum forming or blow molding.

In one embodiment of the first aspect, the support is configured to engage with the dispenser and/or the housing so as to support the vessel within the assembled dispenser and housing such that deformation of the vessel is avoided or lessened when the dispenser is actuated.

In one embodiment of the first aspect, the support is a lip running about an upper end of the vessel and surrounding the opening.

In one embodiment of the first aspect, the lip is supported by the housing.

In one embodiment of the first aspect, the support is a threaded connection or a frictional connection configured to engage with a complimentary threaded or frictional connection on the dispenser or the dispenser retainer, so as to form a seal between the vessel and the dispenser.

In one embodiment of the first aspect, the vessel is fabricated completely or predominantly from an environmentally sustainable material.

In one embodiment of the first aspect, the environmentally sustainable material is a recyclable material, a compostable material, or a material which readily degrades in the environment to substantially non-toxic products.

In one embodiment of the first aspect, the vessel is sealed but is openable by a user so as to provide a vessel opening allowing access to the vessel interior.

In one embodiment of the first aspect, the vessel comprises a separable, frangible, disruptable, or peelable portion at an end thereof, the separable, frangible, disruptable or peelable portion being movable or removable or disruptable by a user so as to provide access to the vessel interior via the opening.

In one embodiment of the first aspect, the system comprises one or more seals configured to (i) inhibit or prevent movement of a movable substance in the vessel to outside the system except for movement of the movable substance via the dispenser. and/or (ii) inhibit or prevent the ingress of a fluid or a vapor or a gas into the system.

In one embodiment of the first aspect, the one or more seals contact the vessel support, or another structure which is itself sealed to the vessel support.

In one embodiment of the first aspect, the vessel housing is configured to mount and/or secure the dispenser retainer in a position so as to allow the dispenser to cause or allow a movable substance to move from the vessel to outside the system.

In one embodiment of the first aspect, the vessel housing is configured to protect the vessel from deformation by a lateral force and/or protect against moisture damage; and/or to support the dispenser.

In one embodiment of the first aspect, the vessel housing is substantially non-deformable.

In one embodiment of the first aspect, the dispenser retainer and/or the vessel housing is/are configured so as to cause or allow mutual engagement therebetween.

In one embodiment of the first aspect, the mutual engagement is a threaded engagement, or a snap-fit engagement, or a frictional engagement.

In one embodiment of the first aspect, the dispenser is a manually actuatable liquid pump having an input in fluid connection the vessel interior and an output opening to outside the system.

In one embodiment of the first aspect, the vessel is devoid of a label, an adhesive or an ink applied thereon.

In one embodiment of the first aspect, the vessel has a label, an adhesive or any ink applied thereon which is removable with an aqueous solution washing step, including a caustic washing step, or a blowing step performed in the course of a recycling process.

In one embodiment of the first aspect, the vessel is formed without any dye, colourant or tint.

In one embodiment of the first aspect, the vessel comprises a first thread about the vessel opening, and the housing or the dispenser or the dispenser retainer comprises a second thread complimentary to the first thread, the system configured such that upon engagement of the first and second threads a connection is formed such that a movable substance can move from the vessel to the dispenser.

In a second aspect, the present invention provides a vessel having any one of more features of the vessel described in the system of any embodiment of the first aspect.

In one embodiment of the second aspect, the vessel holds a movable substance therein.

In one embodiment of the second aspect, the movable substance is a liquid used in personal care or a food product.

In a third aspect, the present invention provides a dispenser configured to cause or allow a movable substance to move from a vessel interior to a vessel exterior, the dispenser having any one of more of the features described in the system of any embodiment of the first aspect.

In a fourth aspect, the present invention provides a method of replenishing a movable substance in a system for holding and dispensing a movable substance, the method comprising the steps of: providing the system of any embodiment of the first aspect, removing a vessel which is empty from the system, providing a replacement vessel which is full of a movable substance, and operably associating the vessel with the dispenser.

In one embodiment of the fourth aspect, the method comprises the step of depositing the vessel removed from the system into a recycling stream, or a degradation stream.

With regard to the first, second, third or fourth aspects of the invention the following embodiments are provided.

In one embodiment, the dispenser retainer is sealingly engageable with the vessel, and may further be rotationally engageable with the vessel.

In one embodiment, the dispenser retainer has a first thread, and the vessel has a complimentary first thread; or the dispenser retainer has a first lug, and the vessel has a complimentary first lug guide; or the vessel has a first lug, and the dispenser retainer has a complimentary first lug guide.

In one embodiment, the dispenser retainer is configured to engage with the vessel housing.

In one embodiment, the dispenser retainer is configured to sealingly engage with the vessel housing.

In one embodiment, the dispenser retainer is rotationally engageable with the vessel housing.

In one embodiment, the dispenser retainer has a second thread, and the vessel housing has a complimentary second thread; or the dispenser retainer has a second lug, and the vessel housing has a complimentary second lug guide; or the vessel housing has a second lug, and the dispenser retainer has a complimentary second lug guide.

In one embodiment, the first and second threads, or the first and second lug and lug guide, are configured to initially mutually engage with their complimentary substantially concomitantly upon rotation of the dispenser retainer.

In one embodiment, the first and second threads, or the first and second lug and lug guide, are configured to initially mutually engage with their complimentary part at a substantially different time upon rotation of the dispenser retainer.

In one embodiment, the pitch of the first and second threads, or the pitch of the lug and lug guide, are set such that upon rotation of the dispenser retainer, the vessel is moved toward the dispenser retainer at substantially the same rate or at a faster rate than the dispenser retainer is moved toward the vessel housing.

In one embodiment, the system is configured to prevent rotation of the vessel relative to the vessel housing, but allow rotation of the dispenser retainer to rotate relative to the vessel.

In one embodiment, the vessel and/or vessel housing is/are configured to prevent rotation of the vessel relative to the vessel housing.

In one embodiment, the vessel comprises a formation extending into a complimentary recess of the vessel housing, the formation and recess configured to prevent rotation of the vessel relative to the vessel housing.

In one embodiment, the vessel has a wall formed from a deformable polymer.

In one embodiment, the vessel comprises a closure.

In one embodiment, the closure is partially or completely separable from the vessel and/or is disruptable so as to gain access to a movable substance contained therein.

In one embodiment, the dispenser or the dispenser retainer comprises a closure disrupting element, and the vessel comprises a disruptable closure, and wherein the system is configured such that the closure disrupting element disrupts the disruptable closure as the dispenser retainer is contacted to or engaged with the vessel housing.

In one embodiment, the closure is applied over an opening of the vessel.

In one embodiment of the first aspect, the closure is a foil or a functional equivalent thereof.

In one embodiment of the first aspect, the closure is devoid of a thread for threaded engagement with the vessel.

In one embodiment, the vessel complimentary first thread or the vessel complimentary first lug guide; or the vessel first lug is located on the connecting portion of the vessel, the connecting portion being formed from a plastic having a thickness greater than that of the remainder of the vessel.

In one embodiment, the connecting portion is a neck portion.

In one embodiment, the connecting portion of vessel extends outwardly from an opening of the vessel housing.

In one embodiment, the vessel is devoid of a screw cap.

In one embodiment of the second aspect, the vessel is enclosed in a vendible form and enclosed in a package.

### BRIEF DESCRIPTION OF THE FIGURES

FIG. 1 illustrates a perspective view of an exemplary pump pack system of the invention. The system is shown partially disassembled so as to reveal the plastic vessel with foil closure which is concealed completely when the system is assembled for use. The foil closure has been pierced by the pump dip tube. The support is provided in the form a lip of the vessel which is supported by the vessel housing.

FIG. 2 illustrates a lateral view of the pump pack system shown in FIG. 1, although with the plastic vessel completely removed from the housing.

FIG. 3 is a diagrammatic cross-sectional view of the pump pack system shown in FIG. 1 and FIG. 2, although in fully assembled form.

FIG. 4 is a magnification of the area delineated by the dashed square in FIG. 3 to more clearly show the sealing means between the plastic vessel and the pump retainer.

FIG. 5A shows an embodiment of the system whereby an annular recess is disposed about the housing, and an elastic band is removably locatable in the recess. The elastic band has text imprinted thereon to allow identification of the movable substance held in the vessel.

FIG. 5B shows the embodiment of FIG. 5A having an elastic band located in the recess.

FIG. 6 shows an embodiment of the invention similar to that of FIG. 1 except that the support of the vessel is provided by a threaded connection between the vessel and the pump.

FIG. 7A shows an embodiment of the system useful for storing and dispensing a sauce. The system is shown partially dissembled with the upper part of the drawing being the recycle vessel disposed within the vessel housing, and the lower part being the dispenser and dispenser retainer.

FIG. 7B shows the underside of the dispenser and dispenser retainer, revealing the slits through which the sauce flows when the dispenser is squeezed by a user.

FIG. 8 illustrates a preferred system of the present invention, in upper perspective view to show the threads formed on the refill vessel and the vessel housing.

FIG. 9 illustrates the system drawn in FIG. 8, although in a lower perspective view to the upper and lower threads formed in the dispenser retainer. In this illustration, the lower part of the pump is not drawn to improve clarity.

FIG. 10 illustrates a cross-sectional view of the system drawn in FIG. 8, although with all components fully assembled.

FIG. 11 is a magnified view of a portion of FIG. 10 to show more clearly the various sealing surfaces.

FIG. 12 illustrates the use of formations and recesses in perspective cross-sectional view only the vessel and the vessel housing of the system drawn in FIG. 8. The formations and recesses prevent rotation of the vessel within the vessel housing.

FIG. 13 illustrates in lateral view the neck of a vessel having a thread of relatively high pitch on the neck, the vessel seated in a vessel housing having a relatively low pitch about its upper edge.

FIG. 14A illustrates in lateral view a system capable of automatic cutting of a vessel closure when the dispenser retainer is wound onto the vessel neck and vessel housing.

FIG. 14B illustrates in lateral view a system capable of automatically piercing a vessel closure when the dispenser retainer is wound onto the vessel neck and vessel housing.

The drawings are not prepared to any particular scale or dimension and are not presented as being a completely accurate presentation of the various embodiments.

### DETAILED DESCRIPTION OF THE INVENTION AND PREFERRED EMBODIMENTS THEREOF

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments, or indeed any embodiment covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

As used herein, positional terms such as “lateral”, “across”, “above”, “below”, “higher”, “lower”, “upward”, “downward”, “plan view” and the like are to be considered with reference to a system of the present invention as used in a normal upright position such that a movable substance in the vessel is settled in the lower region of the vessel.

The present invention is predicated at least in part on the inventor's discovery that an improved environmental outcome is achieved where the plastic vessel portion of a pump-pack system configured to hold and dispense a movable substance is fabricated so as to have a thin lateral wall and a support. The use of a thin lateral wall reduces the amount of material used to fabricate the vessel. Thus, when the system is emptied of the movable substance the vessel is separated from the dispensing portion by the user and is replaced by a fresh vessel (filled with movable substance) and is sealingly engaged with the dispensing device so as to allow for the continued dispensing of movable substance as required by the user. The empty vessel is discarded preferably into a recycling stream, or alternatively into land fill or another non-recycling destination. Where the vessel is recycled, a lesser of amount of energy is required in the recycling process given the lesser amount of material present. Where the vessel is not recycled, a lesser of amount of material enters landfill. The function of the support is to lessen or avoid any deformation of the vessel lateral wall as the dispenser is actuated by a user. For example, where the dispenser is a pump which is operable by a downward force by the user, the support prevents collapse of the vessel as a result of the downward force. In the present system, the vessel housing or the dispenser may be configured to contact the support and carry the downward load effect, and by virtue of their lack of deformability or rigidity effectively support the vessel such that the downward force is not appreciably transferred to the vessel.

As will be discussed further with regard to the preferred embodiments, the support may be a lip or a threaded connection running about the opening of the vessel.

The support may optionally provide one or more sealing surfaces to prevent or inhibit a movable substances from exiting the system inadvertently.

The vessel may be fabricated from any material usable in the fabrication of a vessel that can hold a movable substance, including any man-made polymeric material. It will be generally desirable to utilise polymeric materials that are already in widespread use so as to facilitate production with existing machinery and protocols. In that regard, polyethylene-based materials are preferred including polyethylene terephthalate (also known as PET, PETE or polyester), high density polyethylene, low density polyethylene, and polystyrene.

Vacuum formed plastics are preferred given that the process involves stretching the plastic before setting into a desired shape. The stretching process acts to thin the lateral walls of the vessel thereby reducing the amount of plastic used. Vacuum forming will typically leave any lip unstretched, and therefore thicker than the lateral walls. A relatively thick lip is preferred given that it performs a mechanical support function within the system, and optionally as a sealing surface. In such an embodiment, the vessel have a large opening that is sealed with a foil to contain the movable substance.

Blow molding (regular or extrusion) is a further preferred means for fabricating the vessel. This method is able to produce vessels having an ultra-thin wall (for example, less than 0.25 mm) thereby saving significant amounts of plastic. Blow molding may be used to produce a bottle-like vessel having a threaded neck (being thick and of necessarily rigid construction) and an ultra-thin lateral wall. The threaded neck may be sealed with a screw cap to contain the movable substance, or a foil.

In some embodiments, the vessel is fabricated mainly from a flexible sheet-like plastic, optionally in the form of a bladder-like vessel. In such embodiments, a rigid support will be provided to confer the mechanical support function required in the context of the system. For example, a ring-like rigid plastic structure may be fixed to the upper end of the bladder. The sheet-like plastic may be held taught within the confines of the ring-like structure, so as to facilitate piercing by the dispenser as further described infra.

Preferably the thin-walled material is an environmentally sustainable material in the sense that it can be recycled by commercially feasible means, or will easily compost, or will readily degrade into generally harmless degradation products in a reasonable time period, or is manufactured by processes requiring reduced amounts of energy or by processes which limit the release of a greenhouse gas. In one embodiment, the vessel is fabricated from a recyclable plastic.

In one embodiment of the vessel, the polymeric material comprises a single polymeric species so as to facilitate recycling. In this regard, consideration is had not only to the vessel proper but also any associated structures such as closures, closure retaining rings, handles and the like which may otherwise contaminate the recycling stream for a particular polymer. In selecting one or more polymeric species to be used, regard may be had to the buoyancy of the material(s) in light of the propensity for separation in a flotation tank.

Preferably, the vessel is itself formed from a recycled material, and is itself recyclable. Such materials may be opaque, and are often black in colour due to the inability to bleach colours in plastics.

In other embodiments, the vessel is formed from a substantially transparent recyclable material, and furthermore the material is substantially uncoloured. Typically, such materials are virgin materials (i.e. formed from monomeric subunits de novo), and if mixed with other transparent and uncoloured polymer of the same species can be successfully recycled into transparent and uncoloured raw materials.

Another type of vessel is fabricated from cellulosic materials such as wood pulp. Other suitable materials include bagasse, being a cellulosic material derived from sugar cane or sorghum waste fibres. Where required such materials may be configured so as to be substantially impervious to liquids, for example by the use of a water-tight polymer or wax lining.

Irrespective of the material used to form the vessel, it is preferred that in the final vendible form presented to the consumer the vessel is substantially devoid of any label, adhesive, ink and the like which may contaminate the recycling stream. As will be appreciated, it may be desirable or necessary to include some type of identification on the vessel in the form of text and/or graphics. In such circumstances the label, adhesive, ink and the like may be easily removable with an aqueous solvent, which may be caustic. Preferably, the label, adhesive, ink and the like is removable by a washing step (such as a caustic washing step) or an air blowing process that is included in the recycling process such that there is no onus on the consumer to wash the vessel before sending to the recycling stream.

In one embodiment of the invention, a wash-off label and/or a wash-off adhesive may be used. Exemplary products include UPM Raflatac (New Zealand) RW85C wash-off label and adhesive materials for PET vessels,

In many recycling process, a floatation tank is used to separate polymer types. For example, polyethylene terephthalate will sink while a polyolefin will float. Accordingly, it will be preferable for a refill vessel of the present invention to have a different buoyancy to any closure or any label used. For example, the vessel may be fabricated from polyethylene terephthalate, while a closure or label is fabricated from a polyolefin such as polyethylene or polypropylene.

In some embodiments, the label is a shrink label fabricated from, for example, polyethylene terephthalate glycol. Such labels may be compatible with water soluble inks that would easily dissolve in a caustic washing step.

Alternatively, text and/or graphics may be etched or embossed or otherwise formed into the vessel material.

Use of thin-walled vessels to hold a movable substance in a system configured to hold and dispense a movable substance presents the problem of deformability not only due to the downward forces resulting from actuation of the dispenser, but also other deformation forces.

Deformability is not a problem where a vessel is opened and the contents consumed almost immediately, and without any need to sealingly engage with any device. By contrast, use of thin-walled vessels in the context of the present invention requires the vessel to be handled repeatedly over the course of weeks or even months until emptied, such multiple handlings leading the likelihood of the vessel being deformed by the hand, being dropped, or knocked over, or damaged through the repetitive pressure applied via the manual activation of any associated pump mechanism. Accordingly a difficulty may arise in keeping the vessel in an undeformed state so as to remain sealingly engaged with the pump device, to provide support the pump device (especially when being used to pump), and to remain generally presentable in an aesthetic sense. A deformed vessel may also fail to stand upright thereby inhibiting use on a counter-top. Such problems are particularly applicable to thin-walled plastic vessels.

Cellulose-based vessels present similar problems given the general lack of mechanical rigidity in vessels fabricated therefrom. Such vessels raise the further problem of moisture ingress when placed in wet or humid environments. For example, the movable substance may be a body wash which is used in a shower recess, or a hand wash which sits adjacent about a basin. Moisture in the form of direct water contact, steam or simply high humidity levels may enter the cellulosic matrix causing softening and deformation of the vessel. In some cases, the movable substance contained in the vessel leaks into the environment.

To address the problem of deformability or water ingress (which presents only because of the inventive use of deformable or moisture-sensitive thin-walled vessels in the present invention), a protective housing may be provided to surround the vessel. The housing may be a continuous shell substantially surrounding the vessel, or may be a cage-like contrivance which sufficiently protects the vessel from deformation and/or moisture ingress. While the housing may be reused many times it is preferably fabricated from a recyclable material (such as a recyclable plastic, a cellulosic material, a ceramic, or a vitreous material) such that at the end of its useful life it may also be placed into a recycling stream. Alternatively, the housing may be comprised of a degradable resource such as a sustainable wood material.

In general, the exterior of the housing is configured so as to be aesthetically pleasing. Thus, the housing may be shaped, coloured or otherwise arranged so as have a consumer-acceptable appearance. Brand indicium may be provided on an external face of the housing including company branding and logos. Text and/or graphics descriptive of the vessel contents may also be applied.

In a preferred embodiment of the invention, the vessel is a generally cylindrical vessel having generally circular upper and lower ends.

Where the vessel is cylindrical it may have a diameter (measured at the level half way between the ends) of between about 60 mm and 80 mm. The height of the vessel may be between about 100 mm and 140 mm. Depending on the application, larger and smaller dimensions may be used.

In one embodiment the vessel end is configured to provide a centrally located opening that may be circular.

The vessel may have a separable or disruptable portion which functions to contain the movable substance within the vessel, but when separated from the vessel or disrupted allows access to the movable substance by the dispenser.

A separable portion may be a portion that is completely separable (to be completely removable) or partially separable (to remain attached to the main portion of the vessel at least at one point). The separation may be effected by a mechanical force exerted manually by a user to cause breaking, tearing, sheering, stretching, pulling, squeezing, twisting, crumpling, folding, peeling, deformation or scoring to the point of separation. In some circumstances the separable portion is separable with the assistance of a tool, such as a knife.

A separable or a disruptable portion may be integral with a vessel lateral wall. Alternatively, the separable or disruptable portion may be fabricated separately and fixed over the vessel opening.

Where the separable or disruptable portion is fabricated separately, it may contact and seal with an upper face of the vessel lip. In one embodiment, the separable or disruptable portion is a foil that may be peeled from the vessel to expose the vessel opening.

The separable or disruptable potion may remain attached or otherwise associated with the vessel whilst in situ within the system, and even when the vessel is emptied and removed from the system. In such circumstances, and where the vessel is recyclable, it is preferred that the separable or disruptable portion is fabricated from the same recyclable material as the vessel. Accordingly, all materials may be directed to the same recycling stream, there being no need to separate different materials for direction to different streams. In an even more highly preferred embodiment, the separable or disruptable portion is fabricated from the same recyclable material as the vessel, and the recyclable material is a single species of polymer.

Alternatively, the foil may be left in place within the system and is disrupted (by piercing for example) by the dispenser. As an alternative to a foil, another material may be used such as a polymer or a coated cellulosic material.

In some embodiments, the vessel is fabricated from a plastic and the vessel opening is a small aperture formed in the vessel upper end. A disruptable material (such as a foil) is disposed across the aperture, either on the inner side of the aperture or the outer side of the aperture. When disposed across the aperture inner side, the contents of the vessel may be appreciably pressurised such that the disruptable material is urged against the aperture periphery. Pressure from within the vessel may assist in keeping the disruptable material taught, as to facilitate piercing, for example.

The vessel opening will be generally dimensioned as large as necessary to accommodate any dispenser part required to enter the vessel interior. In some embodiments of the invention, the opening comprises at least about 10%, 15%, 20%, 25%, 30%, 35%, 40%, 45%, 50%, 55%, 60%, 65%, 70%, 75%, 80%, 85%, 90% or 95% of the area of the end of the vessel.

The vessel end may comprise a separable portion which seals the movable substance inside the vessel that is movable or removable by the user in anticipation of using the movable substance therein. To improve recycling efficiency, it is generally preferably for the separable portion to be removable. By that arrangement, the separable portion remains attached to the remainder of the vessel, and all material in the vessel is necessarily recycled.

In some applications, it may be desired for the separable portion to be completely separated (i.e. removed) from the vessel, for example where an opening of maximal width is required or where potential spatial interference caused any connected separable portion is to be avoided. In such cases, the separable portion and/or opening may be configured such that after removal the separable portion may be passed through the opening and remain within the vessel for the duration of use. In the context of the present invention, the presence of the separable portion in the bottom of the vessel will not even be noticed by a consumer. For example, the separable portion may be a foil that is pushed into the vessel by the user through the opening. In such an embodiment the separable portion may be designed so as to fold downwardly and into the vessel interior.

For removal of the separable portion, a graspable portion such as a tab or similar arrangement may be provided thereon.

In some embodiments, the vessel of the present invention is not opened by the disruption of any separable portion, but instead by the use of a disruptable portion of the vessel. As one example, the vessel may comprise an aperture with a foil extending thereacross and sealing with the peripheral regions thereof. When required, the foil is pierced by a user immediately before or at the time of engaging a dispensing portion to the vessel. In the latter circumstance, a component of the dispensing portion (such as a dip tube) may be configured to pierce the disruptable portion as the dispensing portion is engaged with the vessel. Alternatively, a peelable portion may seal with and extend across a vessel aperture with the user removing the peelable portion immediately before engagement with a dispensing portion. It will be understood that the use of separable portions, disruptable portion and peelable portions are contemplated to be used in relation a vessel of any suitable construction and fabricated from any suitable material given the application at hand.

In one embodiment, the vessel is thin walled and therefore has some flexibility in the walls. Where some structural resilience is desired or required (for fitting a dispenser, for example) the vessel may have a minor rigid portion associated or incorporated therewith. Preferably, the rigid portion is formed from the same polymer as the thinned walled portion of the vessel so as to facilitate recycling. In some embodiments the rigid portion has a wall of greater thickness, that end being achievable by blow molding.

The present invention may be embodied in the form of a vessel fabricated from a recyclable material (such as a plastic), having a separable portion or a disruptable portion and the vessel usable in combination with any one or more parts of a dispensing system as described herein. For example, vessel may be in itself a vendible item, or may be combined with any one or more of (and in any combination): a dispenser, a housing, a seal, and a movable substance. Alternatively, the vessel may be used as a component in a method for manufacturing a vessel holding a movable substance, whereby the method comprises filling the vessel with a movable substance.

The present invention may be embodied in the form of a dispenser alone as described herein (and without any thin-walled vessel), the dispenser being configured to sealingly engage with a thin-walled vessel as described herein.

The dispenser of the present system may be any contrivance, arrangement of parts, device or apparatus that causes or allows a movable substance to exit the vessel to outside the system where it may be used by a user. The dispenser will typically be configured so as to prevent exit of a movable substance when not desired, for example when the system is tilted, knocked, dropped or tipped over. Such configuration may be achieved by a restriction in a flow channel, a valve, or a closure such as a removable plug, a removable cap, a lid, or the like.

In some cases, there is no requirement for a closure and the dispenser is simply an opening or a spout in communication with the interior of the vessel, and the movable substance is accessed by the user simply tipping the vessel to a desired angle until the substance moves.

In other embodiments, the dispenser is a pump, including a hand-operable pump, of the type often used to dispense liquid soap, shampoo, sunscreen, moisturiser and the like.

In some embodiments the dispenser is a roll-on type dispenser of the type used on roll-on deodorants.

The dispenser may in some embodiments comprise a compressible portion configured to be manually squeezed by a user so as to cause a movable substance in the thin-walled vessel to be urged from the system. In such embodiments, the dispenser may further comprise a less compressible portion (or a more rigid portion) configured to engage with the thin-walled vessel.

In some embodiments, the system has the outward appearance of a bottle (optionally being sealable or closable by a closure such as a lid or a screw cap). In fact, the bottle portion is comprised of three parts: a thin-walled vessel holding the movable substance, a housing about the vessel, and a dispenser retainer having a channel formed therein and opening into a bottle neck. A closure may comprise a fourth part. The dispenser retainer is screwed onto the housing such that the thin-walled vessel sealingly engages with the channel. The movable substance within the thin-walled vessel can only exit via the channel and bottle neck (when any closure is removed, of course), the sealing engagement preventing any other route of exit thereby obviating any leakage.

The present system may be configured to form a water-tight seal between the dispenser and the thin-walled vessel so as to prevent inadvertent egress of a movable substance from the system. As will be appreciated, a water-tight seal may not be necessary where the movable substance is a dry material such as granular substance and in which some cases no seal at all may be necessary.

Any sealing means of the present system may be formed by dedicated or non-dedicated structures contributed by the dispenser retainer and/or the thin-walled vessel and/or the vessel housing.

In some embodiments a seal is provided having a channel formed therein. The channel is formed in the sealing face of the seal and is dimensioned so as to contact the sides and end of a flange running about the vessel lip. Increasing the number of sealing faces in this way is proposed to achieve a more secure seal.

In some embodiments, multiple sealing means are provided. For example a first sealing means as described above is provided to prevent egress of movable substance moving from the vessel into the dispenser, and a second sealing means is provided to prevent ingress of a liquid, a gas or a vapour into the system. Considering more closely the second sealing means, this functions in wet and humid environments to prevent moisture from entering the system. Particularly, moisture may enter at the junction between the vessel housing and the dispenser retainer and depositing about the thin-walled vessel. The ingress of moisture can lead to the growth of mould within the system, or where the thin-walled vessel is cellulosic contact with moisture can lead to degradation of the vessel.

Where two sealing means are provided, the system may be configured such that the seals commence engagement at staggered times in the process of engaging the dispenser retainer with the vessel housing. For example, the seal preventing egress of movable substance may commence engagement firstly and the seal preventing ingress of moisture may commence engage shortly thereafter, and at a third time point the dispenser retainer and vessel housing are fully coupled. These three time points may arise, for example, during the time taken to fully screw the dispenser retainer onto the vessel housing. In this way, the seal preventing egress of movable substance is compressed to a greater extent than the seal preventing ingress of water. A lower level compression for the seal preventing egress of movable substance may be desired so as to prevent difficulty in unscrewing the dispenser retainer from the vessel housing. The lower level of compression (and therefore a less secure seal) may be acceptable for the less critical task of preventing moisture ingress into the system.

The present invention will now be more fully described by reference to the attached non-limiting embodiments shown in the drawings.

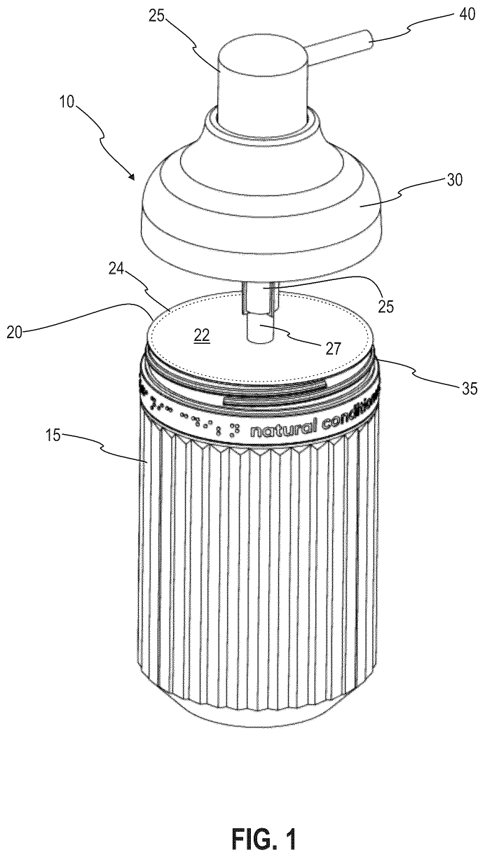

Turning firstly to FIG. 1, there is shown generally an exemplary pump pack system (10) of the present invention suitable for holding and dispensing a personal care composition such as a liquid soap. The system comprises a rigid housing (15), a plastic vessel (20) having a pierceable foil (22) and a lip (24), a pump (25), and a pump retainer (30). The foil (24) extends over and is secured to the lip (24). The system (10) is shown in FIG. 1 with the pump (25) and retainer (30) lifted partly upwardly, to show the dip tube (27) of the pump (25) extending downwardly through the foil (22) an into the vessel (20) interior. When in operation, the pump (25) and pump retainer (30) are engaged with the housing (15) by way of the housing thread (35) (the complimentary thread on the inside lower region of the pump retainer (30) not being visible in this drawing).

The plastic vessel (20) sits snugly within the housing (15), and is therefore protected from deformation given the rigid nature of the housing. The pump retainer (35) is also of rigid construction and functions to also protect the upper edge of the plastic vessel (20) from deformation. As will be more fully described infra, the lip (24) of the plastic vessel (20) functions as a support and a sealing surface so as to prevent leakage of composition from the vessel (20).

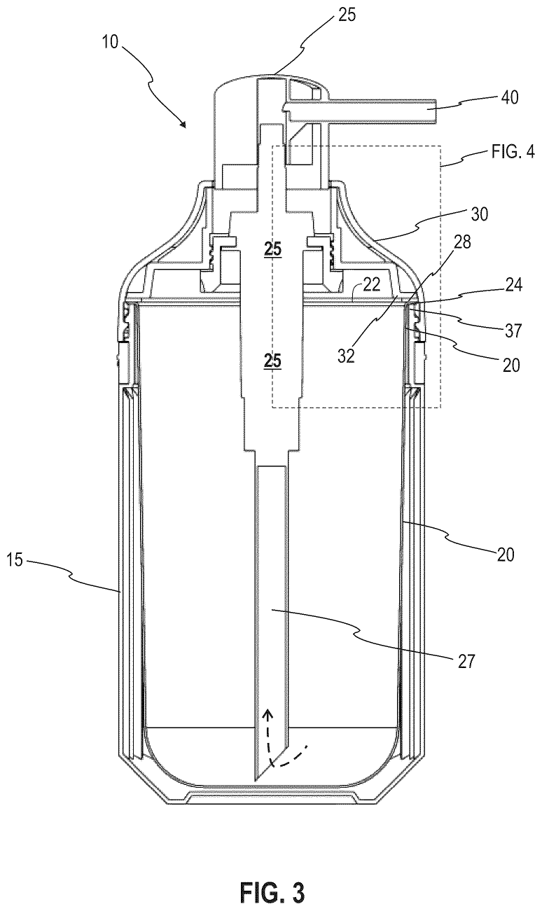

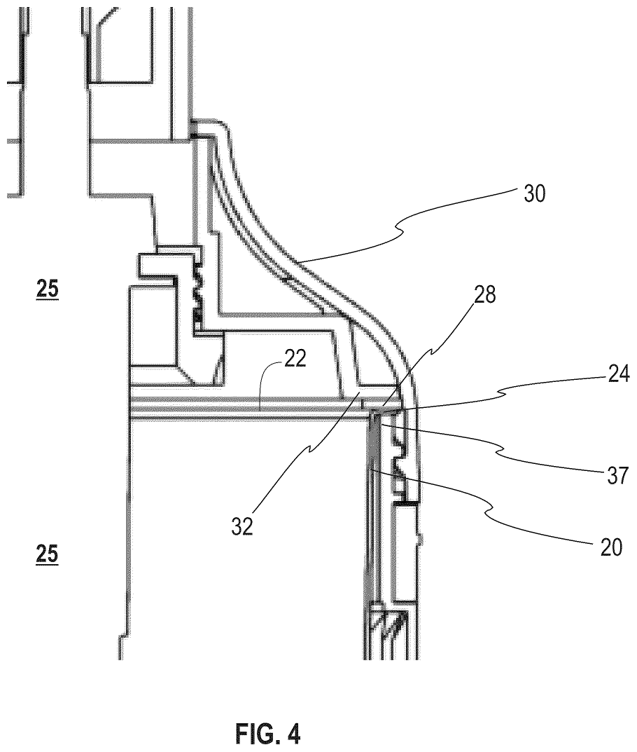

The pump retainer (30) functions to hold the pump (25) in a central position within the interior of the plastic vessel (20) and at an appropriate level such that the pump intake (not visible in FIG. 1) sits just above the floor of the plastic vessel (20). An annular ledge (marked 32 in FIG. 3) of the pump retainer (20) acts to bear downwardly on and retain the lip (24) against an annular ledge (marked 37 in FIG. 3) of the housing (15). In that regard, the lip (24) acts to retain the vessel (20) and also as part of seal formed with the container annular ledge (37) and/or the retainer annular ledge (32). In this embodiment, a discrete annular seal (28) is associated with the retainer annular ledge (32).

The pump (25) is of the hand-actuatable type that draws liquid composition upwardly and expels same through a spout (40). As an alternative, the pump may be triggered automatically (for example by way of a proximity sensor), and/or may rely on an electric motor to transport the movable substance.

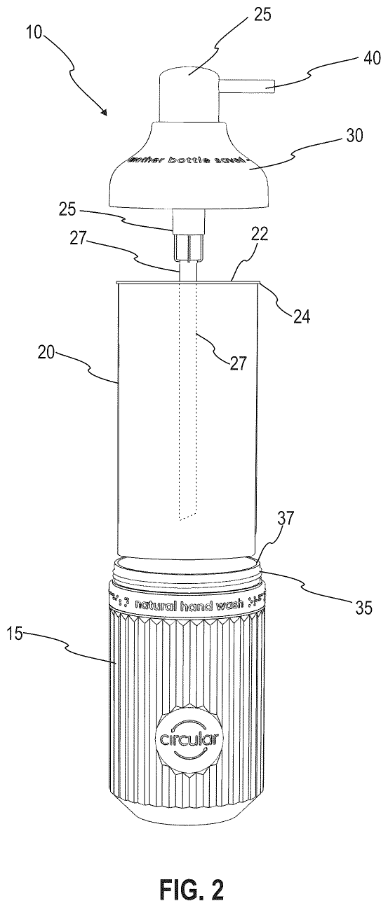

Reference is made to FIG. 2 showing the embodiment of FIG. 1 although with the plastic vessel (20) completely removed from the housing (15) thereby revealing the can-like nature of the vessel (20). This situation would be seen when the system (10) is dissembled by the user to swap an emptied vessel for a new filled vessel.

Referring now to FIG. 3, the same embodiment of FIG. 1 and FIG. 2 is shown, although in fully assembled form (as would be the case when in use and ready to dispense composition) and in cross-sectional view. The view of FIG. 3 shows the dip tube straw (27) of the pump (25). The dip tube (27) has a slanted terminus such that the lower-most part of the straw contacts the base of the plastic vessel (20) although a passage is left open for the composition to be drawn from the vessel and into the straw (45) as indicated by the dashed arrow.

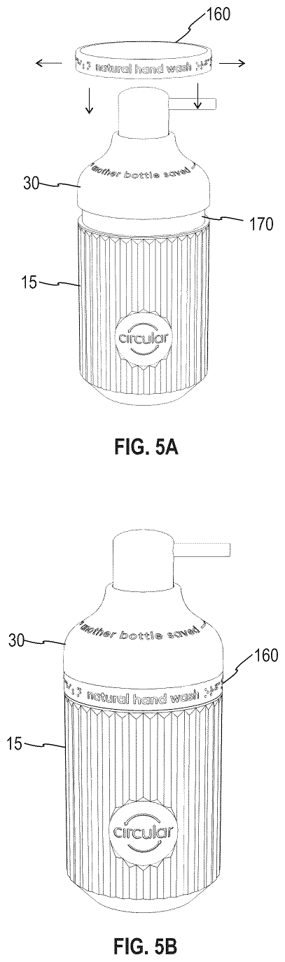

As will be appreciated, in some embodiments a vessel holding the movable substance within the housing will not be visible to a user. Accordingly, the user may not know which movable substance is dispensed by the system. The movable substance may be changed from time to time (for example from a hand soap to a shampoo) causing even greater uncertainty. This may be addressed by providing a window in the housing to expose the vessel exterior, or with the vessel exterior having text or other indicium to identify the contents. Alternatively, (and as shown in FIG. 5A and FIG. 5B) a removable elasticised band (160) may be applied in a recess (170) formed by an edge of the housing (15) and an edge of the retainer (30). As shown by the arrows at FIG. 5A, the band (160) is stretched slightly outwardly and the lowered toward the recess (170), and then released so as to contract inwardly and seat therein as shown at FIG. 5B. The band (160) may be supplied with a vessel containing a movable substance, with the band having indicium thereon allowing a user to identify the substance that will be dispensed.

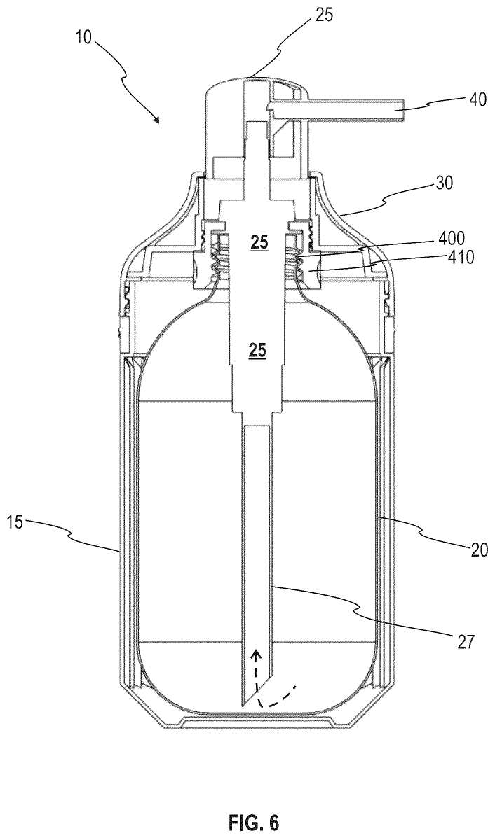

FIG. 6 shows an embodiment whereby the vessel is a blow-molded bottle, and the support portion of the vessel is provided by a threaded neck (400). The threaded neck (400) is connected to a complimentary threaded section (410) of the dispenser retainer (30). Advantageously, the threaded connection between the vessel (20) and the dispenser retainer (30) forms a liquid-tight connection such that liquid drawn into the dispenser (25) is not inadvertently lost. Accordingly, separate support means and sealing means are not required.

The threaded neck (400) was previously sealed by a screw cap or a foil to contain the composition in the vessel. The user removed the cap or foil before winding the retainer (30) onto the vessel (20). Alternatively, the foil may have been pierced by the dip tube (27).

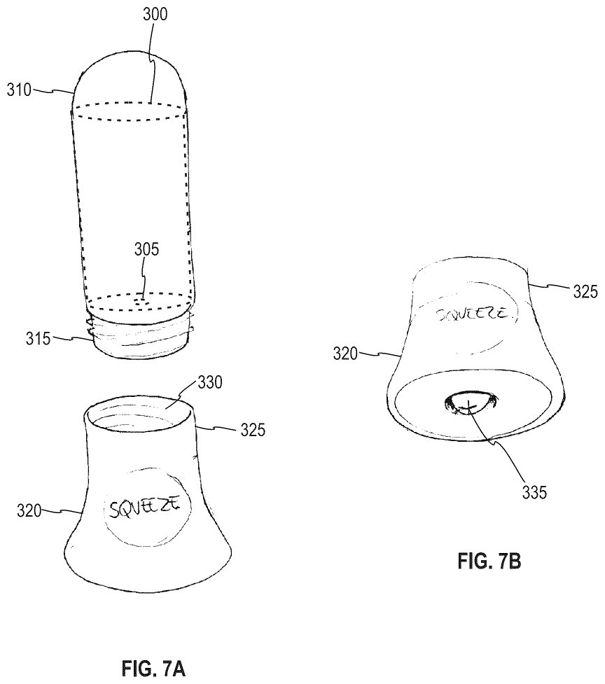

Turning now to FIG. 7A there is shown an embodiment of the present system useful for holding and dispensing a viscous composition such as a sauce, a shampoo, a hair conditioner, a liquid soap, a cooking oil, a mayonnaise, glue, a facial cream or a sunscreen. In this embodiment, the plastic vessel (300) is relatively narrow and having an aperture (305) at its lower end (as drawn), as well as a lip (not drawn). The aperture (305) was previously closed by a peelable foil which is completely removed by the user (and therefore not shown in the drawing) to allow sauce contained in the vessel (300) to pass therethrough. The vessel (300) is retained in and protected by a rigid plastic housing (310) having a threaded lower (as drawn) portion (315). The system further comprises an integral dispenser (320) and dispenser retainer (325). The dispenser retainer is fabricated from a rigid plastic and has an upper (as drawn) threaded region (330) complementary to the lower (as drawn) threaded region (315). Assembly of the system involves winding the vessel housing threaded region (315) with the dispenser retainer threaded region (330), and when complete the sauce is able to pass from the vessel (300) into the dispenser (320). The dispenser (320) is formed from a resiliently deformable material configured to be squeezed by a user thereby urging sauce which has passed thereinto to exit through the crossed slits (335) when the system is assembled. The dispenser (330) functions therefore as a manually operable pump. As an alternative to the threaded engagement shown in FIG. 7A (and indeed any other example of threaded engagement disclosed herein) a clipping engagement, frictional engagement, a pressure fit or other suitable engagement arrangement may be used. As will be appreciated, the crossed slits (335) may be replaced by any other means for preventing flow under gravitational force only, such as a single slit or a narrow aperture.

Containers having thin walls as disclosed elsewhere herein. While effective at reducing the amount of plastic required in production, such containers have limited mechanical strength and may be easily deformable. While deformability is not overly problematic for containers that are handled only once before being discarded (such as a single serving beverage container), for other applications further problems may be raised in some circumstances.

As discussed elsewhere herein, a deformable reduced-plastic container may be used as a refill and in that circumstance the lack of mechanical strength may cause difficulty in connecting a dispenser (such as a liquid pump) to the container. Particularly, when a dispenser is manually connected to the container by a consumer, the dispenser is pushed against the container. Difficulty may arise in making the connection due to the connecting portion of the deformable container retreating from the dispenser as the dispenser is pushed onto it. In that circumstance, the consumer would be required to grasp and hold steady the connecting portion with one hand, and with another hand attempt to connect the dispenser. Some consumers may not possess the manual dexterity required to make the connection, any in any event many would prefer a simplified method of connection.

The present inventor has fond that a reduced plastic deformable refill vessel may be easily connected to a dispenser where the vessel is disposed in a rigid housing and the dispenser is prevented from being pushed downwardly and deforming the vessel by the presence of dispenser retainer that is supported by the housing. Thus, a connecting portion (such as a threaded neck) of the vessel is prevented from any material downward movement and is therefore able to form a connection by way of, for example, engagement with a complimentary thread of the dispenser retainer. The connection is typically sufficiently tight so as to prevent leakage of the movable substance held by the vessel, and may be assisted by one or more seals or sealing surfaces.

The housing and the dispenser retainer may be also mutually connected, by way of complimentary threads for example. Such connection ensures the system components remain associated, even when knocked over or dropped. This connection may be sufficiently tight so as to prevent leakage of movable substance from the connecting portion, and may be assisted by one or more seals or sealing surfaces.

In operation, the consumer removes the dispenser retainer/dispenser and replaces an empty refill in the vessel housing with a full refill. Where the refill is closed with a removable closure, the closure is removed to expose the vessel interior and the movable substance therein. Typically, the closure is disposed over an opening of the vessel connecting portion. For example, the connecting portion may be a neck, and the neck has an opening at its distal end, and the opening is covered by the closure.

The closure may be disruptable and remain in place until disrupted by, for example, the dispenser retainer or dispenser as it is moved toward or through the connecting portion of the vessel. For example, the closure may be a pierceable foil, and the dispenser has an inlet dip tube, and the distal end of the dip tube is pointed so as to facilitate piercing of the foil. Alternatively, the dispenser retainer may comprise one or more piercing elements configured to pierce the foil and allow movable substance to exit the vessel by gravity for example.

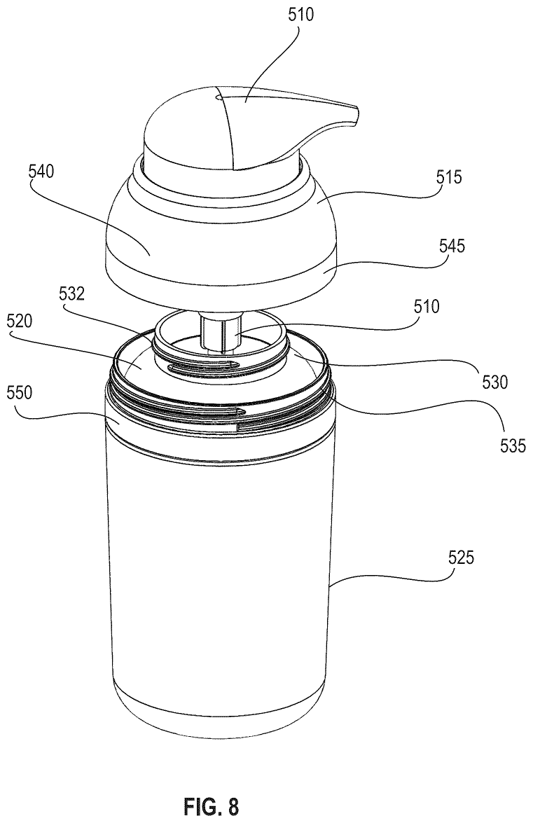

Reference is now made to FIG. 8 through FIG. 14 which illustrate embodiments of the invention whereby a thin-walled refill vessel has a threaded neck, and the dispenser retainer comprises a complimentary thread. In use, the threaded neck of the vessel engages with the dispenser retainer by way of the complimentary threads.

Turning now to FIG. 8, there is shown a system of the present invention comprising a dispenser (510) (being a pump in this embodiment), a dispenser retainer (515), a refill vessel (520) and a vessel housing (525). The system is shown with the dispenser retainer (515) separated from the vessel housing (525) with the pump (510) being partially lifted out of the vessel (520) as would be the case when a freshly opened refill vessel (520) has just been disposed in the housing, and the dispenser (510) is being moved downwardly into the vessel (520), and the dispenser retainer (515) also being moved downwardly so as to eventually be stopped and supported by the vessel housing (525).

FIG. 8 shows the vessel thread (530) and the vessel housing thread (535). The vessel thread (530) winds around the outside of neck portion (532) and engages with an upper complimentary thread (540) on the inside of the dispenser retainer (515). The vessel housing thread engages with a lower complimentary thread (545), also on the inside of the dispenser retainer (515).

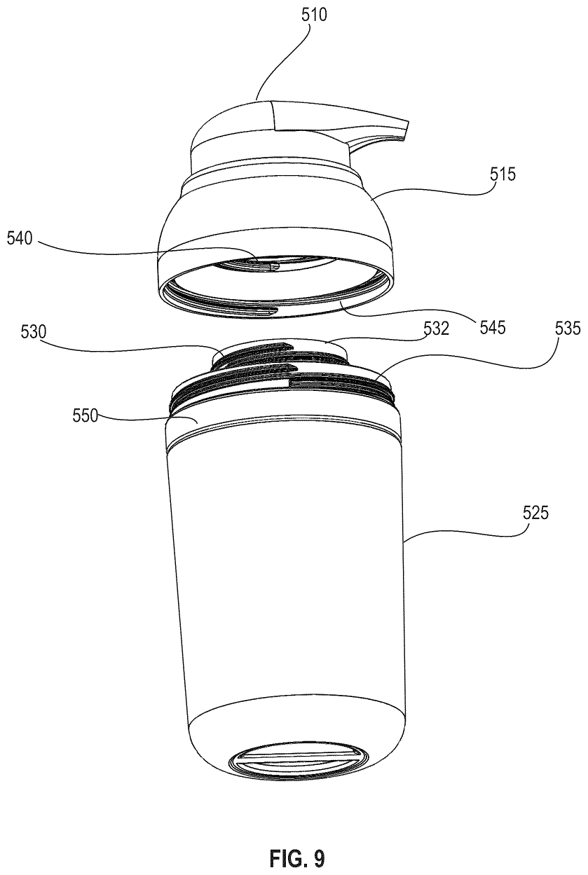

The threads on the inside of the dispenser retainer are more clearly shown in FIG. 9. Note that in FIG. 9 the lower portion of the pump is not drawn so as to more clearly show the inside threads (540) (545) of the dispenser retainer (515).

The vessel (525) comprises also a removable stretchable band (550) having indicium thereon to identify the movable substance within the vessel (520). The band (550) may be removed and replaced when a refill vessel having a different movable substance within it. The band (550) has no other function, and has no function in regards to contacting or engaging with another component of the system.

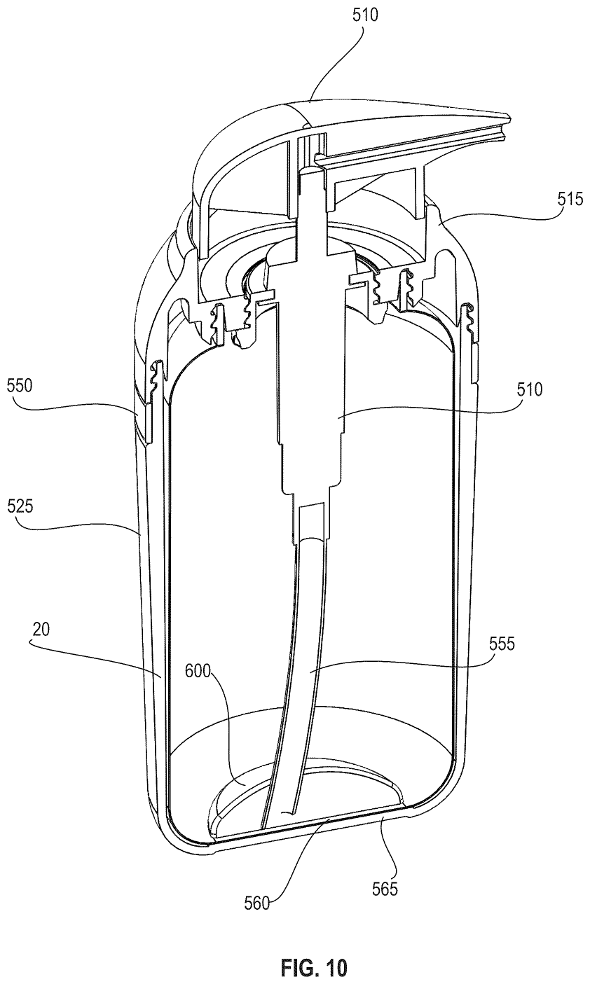

Turning now to FIG. 10, the system is shown in fully assembled form, and is ready to dispense a movable composition (not drawn). It will be noted that a dip tube (555) extends from the pump (510) into a lower region of the vessel (520).

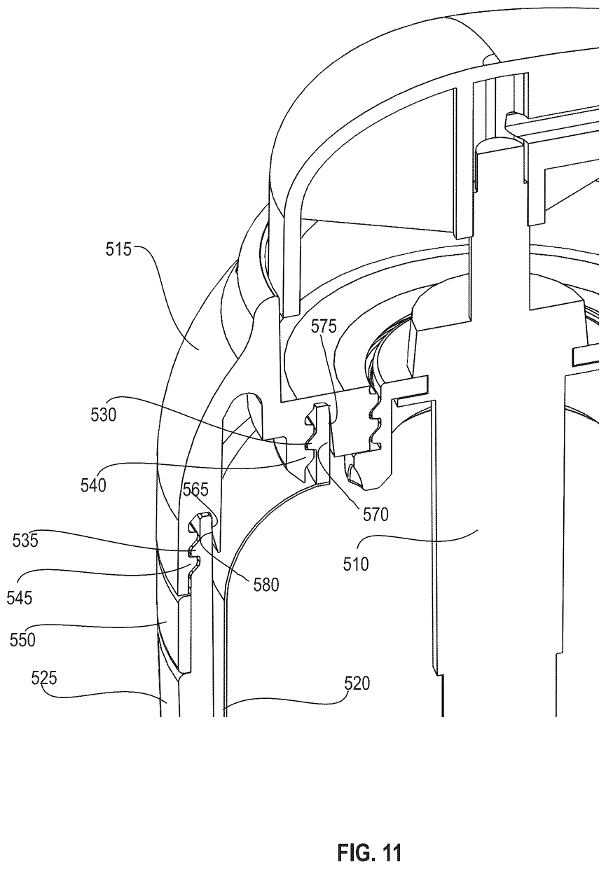

FIG. 11 shows in greater detail the engagement of the various threads in the embodiment drawn in FIG. 10. Particularly, the upper thread (540) of the dispenser retainer (515) fully engaged with the thread (530) of the vessel (520); and the lower thread (545) of the dispenser retainer (515) being fully engaged with the thread (535) of the vessel housing (525).

Returning to FIG. 9 it will be noted that the each of the threads (530) (535) (540) and (545) are configured to engage concomitantly upon winding of the dispenser retainer (515) onto the vessel housing (525). Moreover, the vessel (520) thread (530) is disposed at a predetermined vertical level so as to be in vertical spaced relation to the vessel housing (525) thread (535). The same vertical spaced relationship is provided between the upper (540) and lower (545) threads of the dispenser retainer (515). By this arrangement, no downward force is exerted on the vessel (520) including the vessel neck portion (532) so as to cause the neck portion (532) to move downwardly and retreat as the dispenser (510) and dispenser retainer (515) are moved downwardly.

In operation, the user firstly and rests the dispenser retainer (550) on the vessel housing (515) and the vessel (520) neck portion (532). There is no requirement for the user to circumferentially align any of the threads (530) (535) (540) (545). Upon winding the dispenser retainer (515), all threads are brought into circumferential alignment and thereby engage at the same time. As the dispenser retainer (515) is wound further the pitch of the threads (530) (535) (540) (545) causes the vessel (520) to be drawn toward the upper end of the dispenser retainer (515), while the dispenser retainer (515) is drawn toward the upper end of the vessel housing. Thus, while the dispenser retainer (515) is wound down onto the vessel housing (525) the vessel (520) base (560) is drawn away from the advancing vessel housing (520) base (565) (see FIG. 10) thereby avoiding any deformation of the vessel (520) and therefore avoiding retreat of the vessel (520) neck portion (532) away from its complementary thread (540), thereby allowing mutual engagement and the formation of a connection between the dispenser retainer (515) and the and the vessel (520). The so formed connection is sufficiently tight so as to prevent a movable substance in the vessel from leaking outwardly. The engagement between the threads (530) and (545) is sufficiently tight to maintain all components of the system as a single functional unit.

In one embodiment, each thread comprises two (or more) thread starting points. For example, where two starting points are present, they will typically be opposing (i.e, one at the 0 degrees circumferential position and the other at 180 degrees.). For greater numbers of starting points, the points will be substantially equally spaced about the circumference. For example, for three starting points the positions will be 0 degrees, 120 degrees and 240 degrees. Advantageously, unlike a single thread starting point (where the engagement only occurs once in a 360-degree rotation), there will be at least two starting points in every 360-degree rotation (or one in every 180-degree rotation). By increasing the number of thread starting points, the user experience is simplified as it requires less rotation (and alignment) to engage the threads. Furthermore, by increasing the number of starting points to two or more, the dispenser retainer will sit substantially level prior to thread engagement, as the multiple threads provide an even surface for the closure threads to rest upon.

When fully seated in the vessel housing (525), the neck portion of the vessel (520) may sit slightly proud (for example, 1 mm) over the upper edge of the vessel housing (525). By this arrangement, the user needs to apply a very slight pressure to engage the threads. That very slight pressure gives positive haptic feedback to the user when the threads engage, thereby allowing the user to more rapidly turn the dispenser retainer (515).

The drawn embodiment further comprises seals configured to become operable concomitantly when the user winds on the dispenser retainer, by sealing at the same degree of the dispenser retainer rotation.

Referring now to FIG. 11, when the dispenser retainer (515) is rotated and the threads engage, the screw action effectively draws the vessel (520) upward (relative to the dispenser retainer) thereby creating a positive seal with the sealing between the sealing surfaces (570) and (575). The upward drawing action obviates the need for the refill body to have sufficient structural integrity (axial strength) to resist the axial compression applied when the dispenser retainer (515) is wound on such that a positive seal is created. As discussed above, a deformable vessel would normally retreat upon an axial compressive force, and in the context of a sealing action, no seal would form. In the present invention, as the surface (575) of the refill vessel (520) positively engages with the sealing surface (570) of the dispenser retainer (515) via the upward motion provided by the screw thread feature (and not by axial compression) the seal will remain constant no matter the state of the refill body (i.e., full, empty, structurally compromised, structurally sound etc). Thus, the refill vessel (520) body (i.e. the non-neck portion) can have an ultra-thin wall given that when the refill vessel (520) is filled with a movable substance, the vessel sits in tension (and not compression) thereby taking all load off the body.

A second pair of sealing surfaces are provided a dispenser retainer surface (580) and a vessel housing surface (585). A seal is formed between these surfaces when the dispenser retainer (515) is wound onto the vessel housing (525), and concomitantly with sealing provided by the surfaces (570) and (575). The seal formed by surfaces (580) and (585) may function to prevent the ingress of water (for example, in a bathroom or kitchen setting).

The drawn embodiment shows each sealing surface being integral to its contributing component. In that circumstance the component is fabricated at least in part from a material that is capable of functioning accordingly, and for example a resiliently deformable material may be chosen. Alternatively, discrete sealing means such as O-rings may be used.

The upper (540) and lowers threads (545) may have a different pitch so as to stagger the engagement of the two seals formed upon winding of the dispenser retainer. For example, the pitches may be adjusted such that the first seal made is that between the surfaces (570) and (575) given the importance of preventing leakage of movable substance. That seal will be very tightly formed, with less important seal formed between surfaces (580) and (585) being slightly less tightly formed.

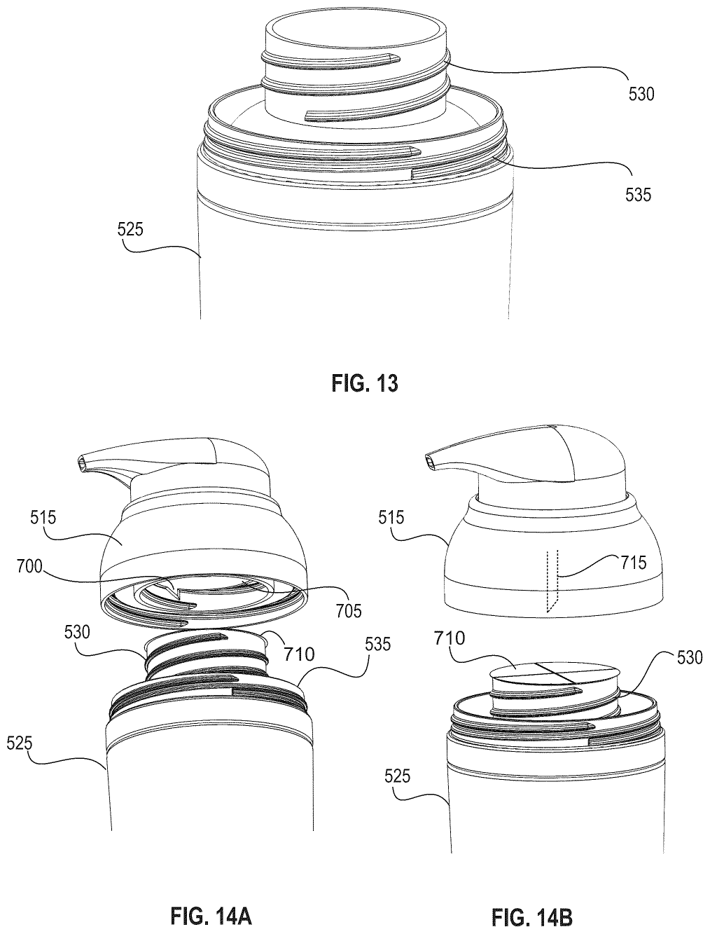

The upper (540) and lowers threads (545) may have a different pitch so as cause the vessel (520) to move a larger distance as the dispenser retainer (515) is rotated by the user. The larger distance may be exploited to provide an automated closure disrupting function. Reference is made to FIG. 13 showing a relatively high pitch thread (530) on the vessel (520) and a relatively low pitch thread (535) on the dispenser housing (515), so as to ensure the vessel (520) is moved a relatively large distance.

Exemplary automatic disrupting arrangements is shown at FIG. 14A and FIG. 14B. Such arrangements may be useful where the dispenser does not have a dip tube, or any other feature capable of disrupting a closure (such as a foil seal) on a vessel. For example, the vessel may be inverted to allow gravity driven movement of the movable substance out of the dispenser.

The arrangement of FIG. 14A includes paired blades (700) and (705) which cut through the seal (710) as the dispenser retainer (515) is rotated so as to expose the vessel (520) interior. The arrangement of FIG. 14B comprises a hollow spike (715) which is forced through the seal (710) as the dispenser retainer (515) is rotated so as to communicate with the vessel (520) interior.

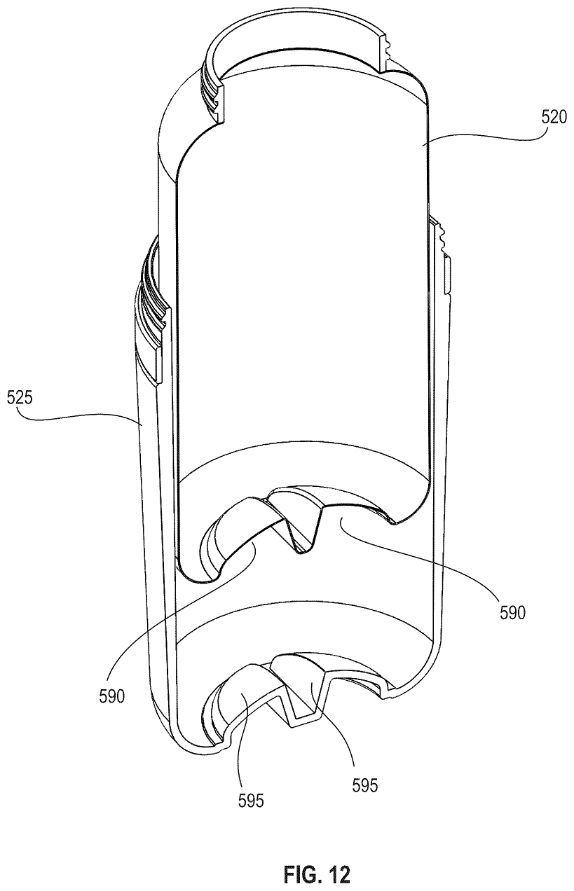

The user will typically grasp the vessel housing (525) to prevent it from rotating when winding on the dispenser retainer (515). To prevent the vessel (520) from rotating, when winding on the dispenser retainer (515) engagement means are provided. In the embodiment shown in FIG. 12, the vessel (520) has a recess (590) formed in the base, and a complimentary formation (595) is provided in the base of the vessel housing (525). The recess (520) and formation (595) each has a pair (not drawn) on the opposing side of the vessel (520) and vessel housing (525).

Referring back to FIG. 10, advantageously the paired recesses (590) can form a bowl (600), with the dispenser (510) dip tube (555) extending into the lower region of the bowel (600). The bowl (600) circumference decreases toward its base so as to provide a pool of movable substance contactable by the dip tube (555) even when the volume of movable substance is very low. By this arrangement the last small volumes of movable substance may be drawn into the dip tube (555) thereby limiting wastage. Moreover, the sloped walls of the bowl (600) function to guide the dip tube (555) into the centre of the bowl (600) again maximising the ability to withdraw substantially all of the movable substance.

As will be appreciated, formations and recesses may be disposed longitudinally along the vessel (520) exterior and vessel housing (525) interior to achieve the same end of preventing rotation of the vessel (520).

When empty, the dispenser retainer (515) can be unwound by the user, and due to the anti-rotation features, all threads will unwind. This will allow the vessel (520) to disengage and release itself from its seal and threaded position. After the dispenser retainer (515) is removed, the vessel (520) is free for removal by the user for placement into the recycling stream.

Any embodiment of the present invention may be used for holding and/or dispensing movable substances such as a flowable substance including a liquid composition, a liquid solution, a liquid emulsion, a liquid mixture, a slurry, a foam, a gel, a powdered substance or a granulated substance. Alternatively, the substance may be substantially non-flowable substances such as a face cream or a thick gel. The dispenser may be chosen according to the movable substance concerned.

The movable substance may have a level of toxicity to humans (as determined by ingestion), and is not safely edible or drinkable. The movable substance may be a personal care substance including but not limited to a liquid soap, a shampoo, a bath additive, a hair conditioner, a hair styling composition (such as a gel), a hair remover, skin conditioner, a skin moisturiser, an artificial tanning composition, a tanning accelerator, a topical medicament, a cosmetic, a sunscreen, a dentifrice, a mouthwash, a shaving lotion, a cologne, an after shave, a skin scrub, and a talcum powder.

The movable substance may be a household agent including but not limited to a cleaning composition, an air freshener, an ironing aid, an insecticide, a herbicide, a lubricant, and a dishwasher drying aid.

The movable substance may be a food, and particularly a non-beverage food, including a sauce, a salad dressing, a mayonnaise, a puree, a concentrate, a condensed milk, or a powdered milk for example.

The movable substance may be used in a heavy or a light industry, and may be an adhesive, a solvent, a diluent, an abrasive, a thermally conducting substance, an electrically conducting substance, a thermally insulating substance, an electrically insulating substance, a catalyst, a dye, a mordant, an etching substance, an acid, or a base.

The present invention has been described by reference to the aspects of a system, a vessel and a method. It will appreciated that any feature described in reference to one aspect is application to any other aspect. For example, where a feature of a vessel is described in relation to the system, that feature is also applicable to the vessel per se (and in the absence of other system components), or to a method that uses the vessel.

The present invention has been described mainly by reference to preferred embodiments comprising a plastic vessel. While plastic vessels are preferred for reasons described elsewhere herein, it will be appreciated that vessels made from other environmentally sustainable thin-walled materials may be utilised in accordance with the general aims of the present invention and in some circumstances may provide for similar advantages as for plastic vessels.

Those skilled in the art will appreciate that the invention described herein is susceptible to further variations and modifications other than those specifically described. It is understood that the invention comprises all such variations and modifications which fall within the spirit and scope of the present invention.

While the invention has been disclosed in connection with the preferred embodiments shown and described in detail, various modifications and improvements thereon will become readily apparent to those skilled in the art.

Accordingly, the spirit and scope of the present invention is not to be limited by the foregoing examples, but is to be understood in the broadest sense allowable by law.

1. A system for holding and dispensing a movable substance, the system comprising:
a vessel configured to hold a movable substance, the vessel comprising (i) a support formed about an upper end thereof and (ii) a deformable lateral wall;
a vessel housing having an upwardly facing opening;
a dispenser configured to cause or allow a movable substance to flow from the vessel to outside the system, and
a dispenser retainer configured to engage the vessel housing and retain the dispenser in operable association with the vessel interior;
wherein the vessel housing or the dispenser is configured to contact the support so as avoid or lessen deformation of the lateral wall upon actuation of the dispenser.

2. The system of claim 1, wherein the vessel lateral wall has a thickness of equal to or less than about 0.5 mm, 0.4 mm, 0.3 mm, 0.2 mm or 0.1 mm.

3. (canceled)

4. The system of claim 1, wherein the support is a vessel lip having a thickness of equal to or greater than about 0.1 mm, 0.2 mm, 0.3 mm, 0.4 mm, 0.5 mm, 0.6 mm, 0.7 mm, 0.8 mm, 0.9 mm or 1.0 mm.

5. (canceled)

6. The system of claim 1, wherein the vessel support has a thickness greater than that of the lateral wall.

7. The system of claim 1, wherein the vessel lateral wall is fabricated from a deformable polymer or a flexible polymer.

8. (canceled)

9. (canceled)

10. The system of claim 1, wherein the vessel is fabricated by a process of vacuum forming or blow molding.

11. The system of claim 1, wherein the support is configured to engage with the dispenser and/or the housing so as to support the vessel within the assembled dispenser and housing such that deformation of the vessel is avoided or lessened when the dispenser is actuated.

12. The system of claim 1, wherein the support is a lip running about an upper end of the vessel and surrounding the opening, and the lip is supported by the housing.

13. (canceled)

14. The system of claim 1, wherein the support is a threaded connection or a frictional connection configured to engage with a complimentary threaded or frictional connection on the dispenser or the dispenser retainer, so as to form a seal between the vessel and the dispenser.

15. (canceled)

16. (canceled)

17. The system of claim 1, wherein the vessel is sealed but is openable by a user so as to provide a vessel opening allowing access to the vessel interior.

18. The system of claim 1, wherein the vessel comprises a separable, frangible, disruptable, or peelable portion at an end thereof, the separable, frangible, disruptable or peelable portion being movable or removable or disruptable by a user so as to provide access to the vessel interior via the opening.

19. The system of claim 1 comprising one or more seals configured to (i) inhibit or prevent movement of a movable substance in the vessel to outside the system except for movement of the movable substance via the dispenser, and/or (ii) inhibit or prevent the ingress of a fluid or a vapor or a gas into the system.

20. The system of claim 19, wherein the one or more seals contact the vessel support, or another structure which is itself sealed to the vessel support.

21. (canceled)

22. The system of claim 1, wherein the vessel housing is configured to protect the vessel from deformation by a lateral force and/or protect against moisture damage; and/or to support the dispenser.

23. The system of claim 1, wherein the vessel housing is substantially non-deformable.

24. The system of claim 1, wherein the dispenser retainer and/or the vessel housing is/are configured so as to cause or allow mutual engagement therebetween.

25. The system of claim 24, wherein the mutual engagement is a threaded engagement, or a snap-fit engagement, or a frictional engagement.

26. The system of claim 1, wherein the dispenser is a manually actuatable liquid pump having an input in fluid connection the vessel interior and an output opening to outside the system.

27. (canceled)

28. (canceled)

29. (canceled)

30. The system of claim 1, wherein the vessel comprises a first thread about the vessel opening, and the housing or the dispenser or the dispenser retainer comprises a second thread complimentary to the first thread, the system configured such that upon engagement of the first and second threads a connection is formed such that a movable substance can move from the vessel to the dispenser.

31. A vacuum formed or blow molded vessel configured to hold a movable substance, the vessel comprising a support formed about an upper end thereof and a deformable lateral wall having a thickness of less than about 0.3 mm, the vessel support being thicker than the lateral wall, the vessel comprising a thread about the opening, the vessel comprising a separable, frangible, disruptable, or peelable portion, the separable, frangible, disruptable or peelable portion being movable or removable or disruptable by a user so as to provide access to the vessel interior via the opening.

32. (canceled)

33. (canceled)

34. (canceled)

35. (canceled)

36. (canceled)
